(19) United States
(12) Patent Application Publication
(10) Pub. No.: US 2004/0114087 A1
(43) Pub. Date: Jun. 17, 2004

(54) Liquid crystal display, panel therefor, and manufacturing method thereof

(76) Inventors: Young-Je Cho, Cheonan-city (KR); Woo Choi, Cheonan-city (KR); Jeong-Ho Lee, Seoul (KR)

Correspondence Address: Frank Chau, Esq., F. CHAU & ASSOCIATES, LLP, 1900 Hempstead Turnpike, East Meadow, NY, 11554, US

(21) Appl. No.: 10/672,304

(22) Filed: Sep. 26, 2003

(30) Foreign Application Priority Data
Sep. 26, 2002 (KR) 2002-58391
May 20, 2003 (KR) 2003-31838

(51) Int. Cl. G02F 1/1339

(52) U.S. Cl. 349/155

(57) ABSTRACT

A panel assembly for a liquid crystal display is provided. The panel assembly includes a panel and a plurality of spacers formed on the panel for supporting the panel. The spacers have at least two different heights or at least two different contact areas with the panel. The spacers include a plurality of first spacers and a plurality of second spacers having a height lower than the first spacers and having a contact area wider than the first spacers. The height difference between the first spacers and the second spacers is preferably in a range of about 0.3-0.6 microns, and the second spacers have a length larger than the first spacers preferably by 10-20 microns.

### BACKGROUND OF THE INVENTION

(a) Field of the Invention

The present invention relates to a panel for a liquid crystal display, a panel therefor, and a manufacturing method thereof, and in particular, to a liquid crystal display including spacers.

(b) Description of Related Art

Generally, a liquid crystal display (LCD) includes two panels including field-generating electrodes and coated with alignment layers and a liquid crystal (LC) layer having dielectric anisotropy and filled in a gap (called a cell gap) between the panels. Electric fields are applied to the LC layer by using field-generating electrodes and the transmittance of light passing through the panels are controlled by adjusting the field strength, thereby displaying desired picture images.

The two panels are assembled by printing a sealant along a periphery of one of the panels and by hot-pressing the panels.

The cell gap between the panels are supported by elastic spacers provided between the panels and the sealant also includes spacers for maintaining the cell gap. The LC layer is encapsulated by the sealant. The spacers includes spherical spacers spread on the panels and columnar spacers formed by photolithography.

The columnar spacers are vertically compressed to support the panels. When the cross sections of the spacers are too small to cause large compression deformation, the spacers are apt to be deformed or to be damaged. On the contrary, if the cross sections of the spacers are too large to cause small compression deformation, it is difficult to adjusting the amount of the LC material to be filled in the gap between the panels. The inappropriate amount of the LC causes bubbles or non-uniform distribution of the LC.

In particular, it becomes important to keep the cell gap uniform and to facilitate the formation of the LC layer as the LCD becomes large.

### SUMMARY OF THE INVENTION

It is a motivation of the present invention to keep the cell gap uniform and to facilitate the formation of the LC layer.

A panel assembly for a display device is provided, which includes: a panel; and a plurality of spacers formed on the panel for supporting the panel, wherein the spacers have at least two different heights or at least two different contact areas with the panel.

The contact areas of the spacers are circular or tetragonal.

The spacers preferably include a plurality of first spacers and a plurality of second spacers having a height lower than the first spacers and having a contact area wider than the first spacers. The height difference between the first spacers and the second spacers is preferably in a range of about 0.3-0.6 microns, and the second spacers have a length larger than the first spacers preferably by 10-20 microns. It is preferable that the second spacers have a length in a range of about 30-35 microns and the first spacers have a length in a range of about 15-20 microns.

Preferably, a concentration of the second spacers is about 200-600/cm² and a concentration of the first spacer is about 250-450/cm².

The spacers preferably include a first spacer, a second spacer having a height lower than the first spacer, and a third spacer having a height equal to or lower than the second spacer. The height of the third spacer is preferably equal to the height of the second spacer.

The panel may include a gate line and a data line transmitting electrical signals, a thin film transistor electrically connected to the gate line and the data line, and a pixel electrode connected to the thin film transistor. Alternatively, the panel includes a plurality of color filters having different thicknesses.

A liquid crystal display is provided, which includes: a first panel; a second panel opposite each other with a gap therebetween and including a pixel electrode, a switching element connected to the pixel electrode, and a gate line and a data line connected to the switching element for transmitting electrical signals; a plurality of spacers formed between the first panel and the second panel for maintaining the gap; and a liquid crystal layer filled in the gap, wherein the spacers have at least two different contact areas with the panels.

According to an embodiment of the present invention, a method of manufacturing a liquid crystal panel assembly is provided, which includes: coating a photoresist on a panel; light-exposing the photoresist through an exposure mask including an opening and disposed on the panel with a first distance; light-exposing the photoresist through the exposure mask disposed on the panel with a second distance; and developing the photoresist to form first and second spacers having different heights or different contact areas with the panel.

According to another embodiment of the present invention, a method of manufacturing a liquid crystal panel is provided, which includes: coating a photoresist on a panel; light-exposing the photoresist through a first exposure mask including a first opening; light-exposing the photoresist through a second exposure mask including a second opening; and developing the photoresist to form first and second spacers having different heights or different contact areas with the panel.

According to another embodiment of the present invention, a method of manufacturing a liquid crystal panel is provided, which includes: coating a photoresist on a panel; light-exposing the photoresist through an exposure mask including a plurality of transmissive areas having different transmittances and a blocking area; and developing the photoresist to form a plurality of spacers having different heights or different contact areas with the panel.

The plurality of transmissive areas may include a transparent area and a translucent area. Preferably, the transparent area has an opening and the translucent area has a plurality of slits.

The plurality of transmissive areas may include a transparent area and a plurality of translucent areas having different transmittances.

The photoresist is preferably a negative type.

### BRIEF DESCRIPTION OF THE DRAWINGS

The above, and other advantages of the present invention will become more apparent by describing preferred embodiments thereof in detail with reference to the accompanying drawings in which:

FIG. 1 is a plan view of a panel assembly for an LCD according to an embodiment of the present invention;

FIG. 2 is a sectional view of the panel assembly shown in FIG. 1 taken along the line II-II′;

FIG. 3 is a sectional view of a panel and a plurality of column spacers formed thereon for the LCD shown in FIG. 2 before panel combination according to an embodiment of the present invention;

FIGS. 4A and 4B are sectional views of a LC panel assembly shown in FIG. 3 in intermediate steps of a manufacturing method thereof according to an embodiment of the present invention;

FIGS. 5A and 5B are sectional views of a LC panel assembly shown in FIG. 3 in intermediate steps of a manufacturing method thereof according to another embodiment of the present invention;

FIG. 6 is a sectional view of a LC panel assembly shown in FIG. 3 in an intermediate step of a manufacturing method thereof according to another embodiment of the present invention;

FIG. 7 is a layout view of an LCD according to an embodiment of the present invention;

FIG. 8 is an exemplary sectional view of the LCD shown in FIG. 7 taken along the line VIII-VIII′;

FIG. 9 is another exemplary sectional view of the LCD shown in FIG. 7 taken along the line VIII-VIII′;

FIG. 10 shows exemplary locations of the first and the second spacers 321 and 322 shown in FIG. 2 according to an embodiment of the present invention;

FIGS. 11 is a plan view of a panel assembly for an LCD according to an embodiment of the present invention;

FIGS. 12 is a sectional view of the panel assembly shown in FIGS. 11 taken along the line XII-XII′;

FIG. 13 is a sectional view of a panel and a plurality of column spacers formed thereon for the LCD shown in FIG. 12 before panel combination according to another embodiment of the present invention;

FIG. 14 is a sectional view of a LC panel assembly in an intermediate step of a manufacturing method thereof according to an embodiment of the present invention;

FIG. 15 is a sectional view of a LC panel assembly in an intermediate step of a manufacturing method thereof according to another embodiment of the present invention;

FIG. 16 is a layout view of an LCD according to an embodiment of the present invention;

FIGS. 17 and 18 are sectional views of the LCD shown in FIG. 16 taken along the line XVII-XVII′ and the line XVIII-XVIII′, respectively; and

FIG. 19 shows exemplary locations of the spacers shown in FIGS. 12-18 according to an embodiment of the present invention.

### DETAILED DESCRIPTION OF PREFERRED EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

Now, liquid crystal displays, panels for a liquid crystal display, and manufacturing methods thereof according to embodiments of the present invention will be described with reference to the accompanying drawings.

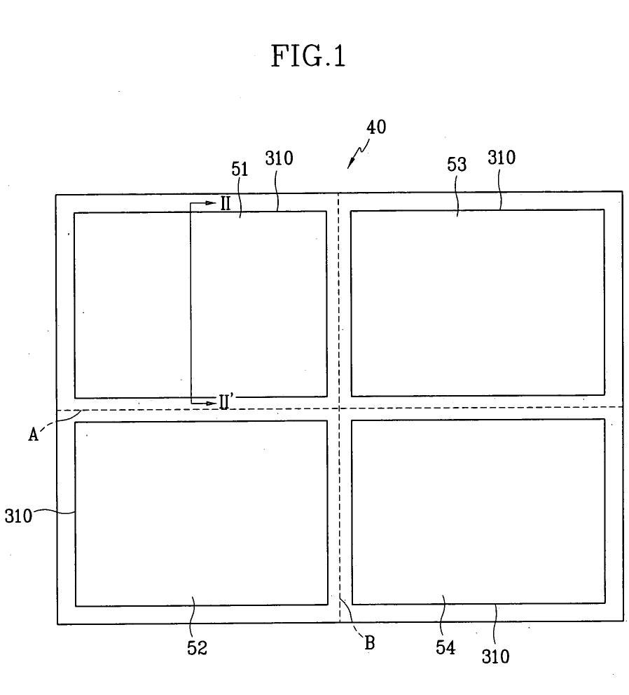

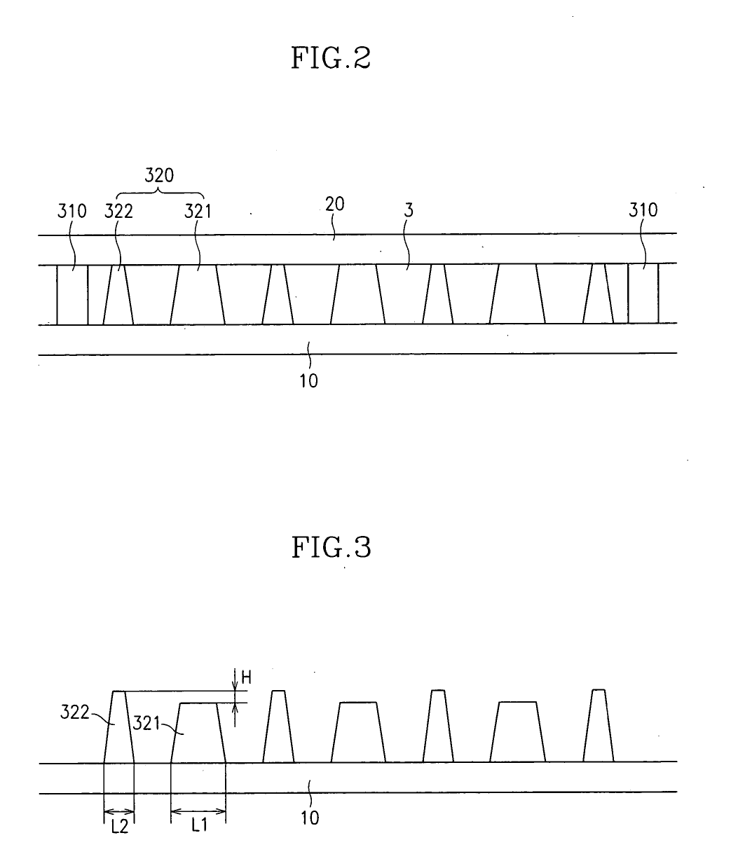

A panel assembly for LCDs according to an embodiment of the present invention will be now described in detail with reference to FIGS. 1 and 2.

FIG. 1 is a plan view of a panel assembly for LCDs according to an embodiment of the present invention and FIG. 2 is a sectional view of the panel assembly shown in FIG. 1 taken along the line II-II′.

As shown in FIGS. 1 and 2, a panel assembly 40 according to an embodiment of the present invention includes two panels 10 and 20 and a plurality of LC layers 3, a plurality of sealants 310, and a plurality of columnar spacers 320, which are disposed between the two panels 10 and 20.

The panel assembly 40 includes a plurality of, for example, four device areas divided by dotted lines A and B. The panel assembly 40 is separated into the respective LCDs by scribing the panel assembly 40 along the dotted lines A and B.

Each of the device areas (or an LCD) includes a display area 51, 52, 53 or 54 for displaying images. The display area 51 is substantially enclosed by the sealant 310, which confines the LC layer 3. The LC layer 3 may be formed after the panel assembly 40 is separated into the respective devices.

The spacers 320 are provided for maintaining a gap between the panels 10 and 20 to be uniform and the sealant 310 may contain spacers for supporting the panels 10 and 20 to be parallel to each other.

As shown in FIG. 2, the spacers 320 includes a plurality of first and second spacers 321 and 322 contacting the panels 10 and 20 with different contact areas and sizes. The different contact areas of the spacers 321 and 322 are obtained by forming spacer columns with different heights and by pressing the spacer columns to have the same height.

FIG. 3 is a sectional view of a panel and a plurality of column spacers formed thereon for an LCD before panel combination according to an embodiment of the present invention.

A plurality of first and second column spacers 321 and 322 having different top and/or bottom areas and different heights are formed on a panel 10. The first spacers 321 are shorter and wider than the second spacers 322 as shown in FIG. 3.

Top and bottom surfaces of the column spacers 321 and 322 have a shape of a circle with a diameter or a tetragon with edges. The diameter or edge (hereinafter referred to as “length”) L1 of the bottom surface of each first spacer 321 is longer than the length L2 of each second spacer 322. The height difference H is preferably about 0.3 to 0.6 microns. It is preferable that the length L1 of the first spacers 321 ranges from about 30 microns to about 35 microns while the length L2 of the second spacers 322 is in a range between about 15-20 microns such that the length difference (L1-L2) ranges from about 10 microns to about 20 microns. It is also preferable that the bottom areas of the first and the second spacers 321 and 322 are in a range between about 600-1,100 square microns and in a range between about 150-350 square microns, respectively.

Since the first spacers 321 exhibit small compression deformation and are advantageous for dispersing the stress, they are capable of keeping a cell gap between the two panels 10 and 20 uniform. On the contrary, since the second spacers 322 exhibit large compression deformation, they facilitate to adjust an amount of LC for forming the liquid crystal layer 3.

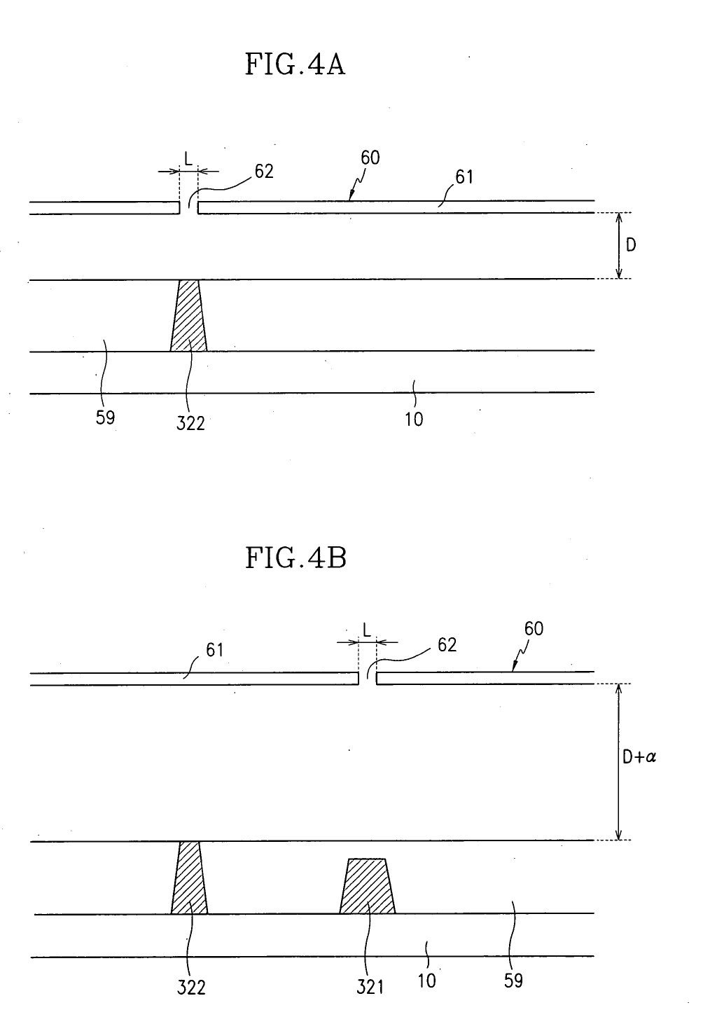

Now, methods of manufacturing the spacers shown in FIG. 3 according to embodiments of the present invention are described in detail with reference to FIGS. 4A-6.

FIGS. 4A and 4B are sectional views of a LC panel assembly shown in FIG. 3 in intermediate steps of a manufacturing method thereof according to an embodiment of the present invention.

Referring to FIG. 4A, a negative acrylic photoresist 59 is coated on a LC panel 10. An exposure mask 60 including an opaque film 61 having a plurality of openings 62 with a length L are disposed on the panel 10 with a distance D. The exposure mask 60 is aligned such that the openings 62 face portions of the photoresist 59 to become the second spacers 322 shown in FIG. 3. The photoresist 59 is then exposed to light from a light source through the exposure mask 60 so that the portions of the photoresist 59 exposed to light be hardened.

Referring to FIG. 4B, the exposure mask 60 is moved in horizontal and vertical directions such that it is spaced apart from the panel 10 by a distance (D+α), where α is positive, and the openings 62 face portions of the photoresist 59 to become the first spacers 321 shown in FIG. 3. The photoresist 59 suffers light exposure through the exposure mask 60. Since the distance (D+α) is larger than the distance D, the exposed portions of the photoresist 59 in this step have larger areas than those in the previous step due to the diffraction of light, and in addition, the intensity of the light reaching the photoresist 59 in this step is weaker than that in the previous step. Accordingly, the first spacers 321 become wider and shorter than the second spacers 322.

An experiment was successfully performed under the condition that a light source with luminance of 100-300 mJ/cm² was used, the diameter of the openings 62 was 10-15 microns, the distance D between the exposure mask 60 and the panel 10 was 100-200 microns, and the distance (D+α) was 300-400 microns.

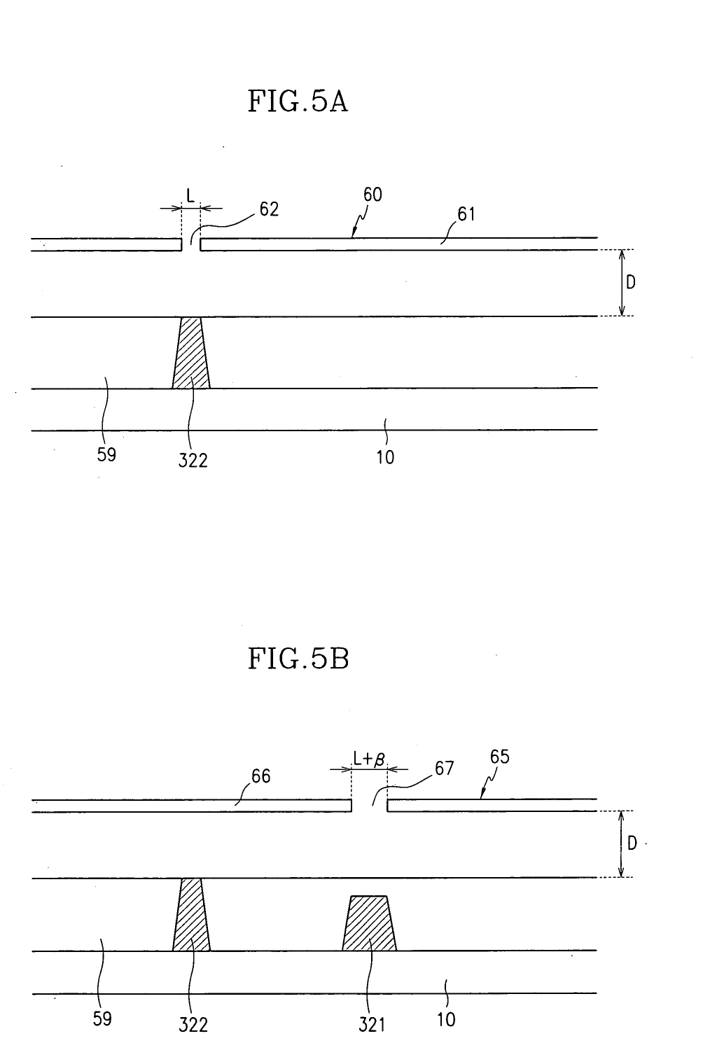

FIGS. 5A and 5B are sectional views of a LC panel assembly shown in FIG. 3 in intermediate steps of a manufacturing method thereof according to another embodiment of the present invention.

The step shown in FIG. 5A is similar to the step shown in FIG. 4A. That is, after a negative acrylic photoresist 59 is coated on a LC panel 10, an exposure mask 60 including an opaque film 61 having a plurality of openings 62 with a length L is disposed on the panel 10 with a distance D and the photoresist 59 is then exposed to light from a light source through the exposure mask 60 so that portions of the photoresist 59 exposed to light are hardened to be the second spacers 322 shown in FIG.3.

Referring to FIG. 5B, another exposure mask 65 an opaque film 62 having a plurality of openings 67 with a length L+β, where β is positive, is disposed on the panel 10 such that the openings 67 face portions of the photoresist 59 to become the first spacers 321 shown in FIG. 3. The photoresist 59 is exposed to light from another light source with a luminance weaker than that of the light source used in the previous step. Alternatively, the light source used in the previous step is still used with a longer distance from the panel 10.

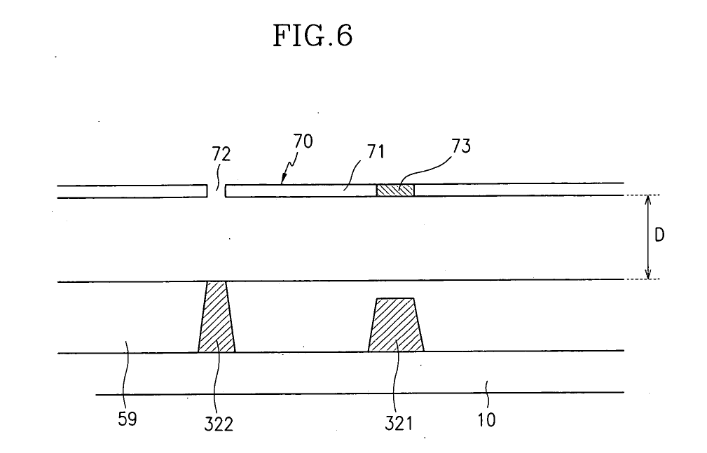

FIG. 6 is a sectional view of a LC panel assembly shown in FIG. 3 in an intermediate step of a manufacturing method thereof according to another embodiment of the present invention.

Referring to FIG. 6, after a negative acrylic photoresist 59 is coated on a LC panel 10, an exposure mask 70 having a plurality of transparent areas, a plurality of translucent areas, and an opaque area is disposed on the panel 10 with a distance D. The opaque area and the translucent areas include an opaque film 71 and a plurality of translucent films 73, respectively, while the transparent areas have a plurality of openings 72. The exposure mask 70 is aligned such that the openings 72 and the translucent films 73 face portions of the photoresist 59 to become the second spacers 322 and the first spacers 321 shown in FIG. 3, respectively. The photoresist 59 is then exposed to light from a light source through the exposure mask 70.

The spacers 321 and 322 may be made from a positive photoresist, and in this case, the opaque areas and the transparent areas shown in FIGS. 4A-6 are reversed.

One of the panels 10 and 20 shown in FIGS. 2-6 is called a thin film transistor (TFT) array panel provided with a plurality of gate lines and a plurality of data lines for transmitting electrical signals such as scanning signals and data signals, a plurality of TFTs electrically connected to the gate lines and the data lines for controlling the data signals, and a plurality of pixel electrodes receiving the data voltages for driving the LC molecules.

The other of the panels 10 and 20 shown in FIGS. 2-6 is provided with a common electrode facing the above-described pixel electrodes to generate electric fields for driving the LC molecules, and a plurality of color filters for color display.

The color filters or the common electrode may be formed on the TFT array panel.

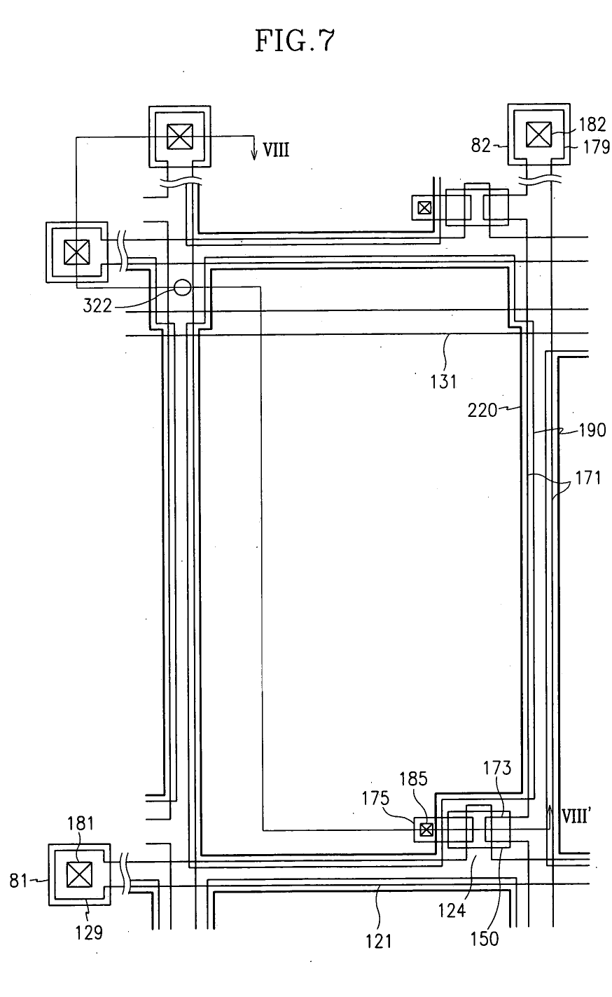

An exemplary LC panel assembly according to an embodiment of the present invention will be described in more detail with reference to FIGS. 7-9.

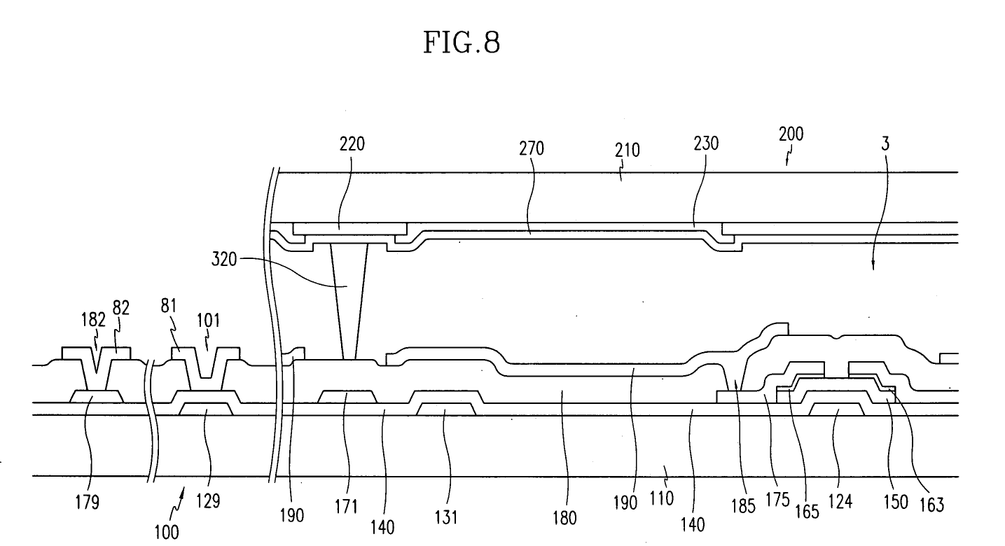

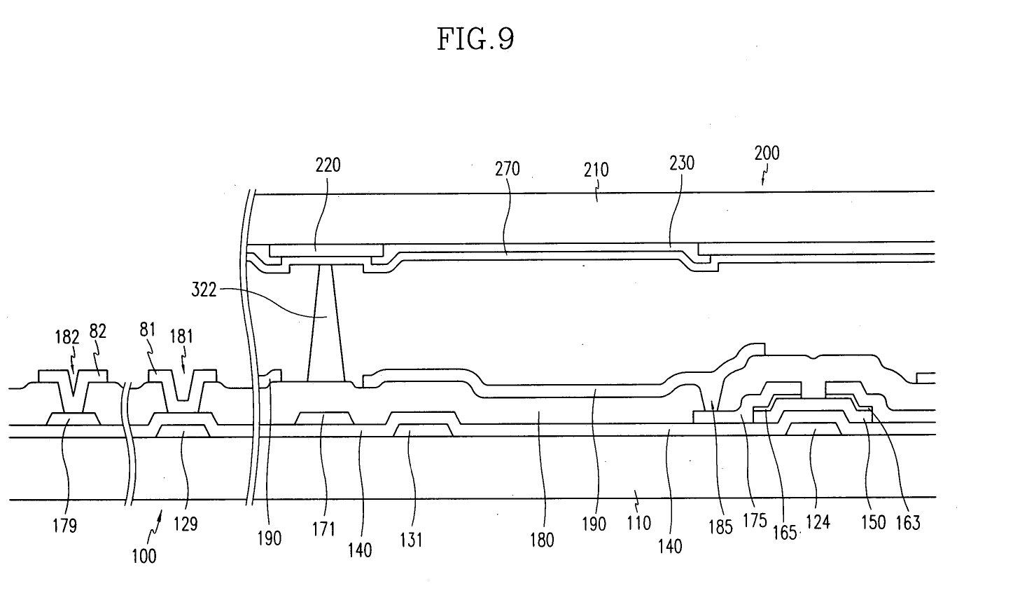

FIG. 7 is a layout view of an LCD according to an embodiment of the present invention, FIG. 8 is an exemplary sectional view of the LCD shown in FIG. 7 taken along the line VIII-VIII′, and FIG. 9 is another exemplary sectional view of the LCD shown in FIG. 7 taken along the line VIII-VIII′.

An LCD according to an embodiment of the present invention includes a TFT array panel 100, a common electrode panel 200, and a LC layer 3 and a plurality of column spacers 320 disposed between the panels 100 and 200.

The TFT array panel 100 is now described in detail.

A plurality of gate lines 121 for transmitting gate signals and a plurality of storage electrode lines 131 are formed on an insulating substrate 110.

The gate lines 121 and the storage electrode lines 131 extend substantially in a transverse direction and are separated from each other. A plurality of projections of each gate line 121 form a plurality of gate electrodes 124. The storage electrode lines 131 are supplied with a predetermined voltage such as a common voltage, which is applied to a common electrode 270 on the common electrode panel 200 of the LCD.

The gate lines 121 and the storage electrode lines 131 may have a multi-layered structure including two films having different physical characteristics, a lower film (not shown) and an upper film (not shown). The upper film is preferably made of low resistivity metal including Al containing metal such as Al and Al alloy for reducing signal delay or voltage drop in the gate lines 121 and the storage electrode lines 131. On the other hand, the lower film is preferably made of material such as Cr, Mo and Mo alloy, which has good contact characteristics with other materials such as indium tin oxide (ITO) or indium zinc oxide (IZO). A good exemplary combination of the lower film material and the upper film material is Cr and Al—Nd alloy.

In addition, the lateral sides of the gate lines 121 and the storage electrode lines 131 are tapered, and the inclination angle of the lateral sides with respect to a surface of the substrate 110 ranges about 30-80 degrees.

A gate insulating layer 140 preferably made of silicon nitride (SiNx) is formed on the gate lines 121 and the storage electrode lines 131.

A plurality of semiconductor islands 150 preferably made of hydrogenated amorphous silicon (abbreviated as “a-Si”) or polysilicon are formed on the gate insulating layer 140. The semiconductor islands 150 are located opposite the respective gate electrodes 124.

A plurality of ohmic contact islands 163 and 165 preferably made of silicide or n+ hydrogenated a-Si heavily doped with n type impurity are formed on the semiconductor islands 150.

The lateral sides of the semiconductor islands 150 and the ohmic contacts 163 and 165 are tapered, and the inclination angles thereof are preferably in a range between about 30-80 degrees.

A plurality of data lines 171 and a plurality of drain electrodes 175 separated from each other are formed on the ohmic contacts 163 and 165 and the gate insulating layer 140.

The data lines 171 for transmitting data voltages extend substantially in the longitudinal direction and intersect the gate lines 121 and the storage electrode lines 131. A plurality of branches of each data line 171, which project toward the drain electrodes 175, form a plurality of source electrodes 173. A source electrode 173 and a drain electrode 175 in a pair are separated from each other and opposite each other with respect to a gate electrode 124. A gate electrode 124, a source electrode 173, and a drain electrode 175 along with the semiconductor island 150 form a TFT having a channel between the source electrode 173 and the drain electrode 175.

The data lines 171 and the drain electrodes 175 may also include a lower film (not shown) preferably made of Mo, Mo alloy or Cr and an upper film (not shown) located thereon and preferably made of Al containing metal.

Like the gate lines 121 and the storage electrode lines 131, the data lines 171 and the drain electrodes 175 have tapered lateral sides, and the inclination angles thereof range about 30-80 degrees.

The ohmic contacts 163 and 165 are interposed only between the underlying semiconductor islands 150 and the overlying data lines 171 and the overlying drain electrodes 175 thereon and reduce the contact resistance therebetween.

A passivation layer 180 is formed on the data lines 171 and the drain electrodes 175, and exposed portions of the semiconductor islands 150, which are not covered with the data lines 171 and the drain electrodes 175. The passivation layer 180 is preferably made of photosensitive organic material having a good flatness characteristic, low dielectric insulating material such as a-Si:C:O and a-Si:O:F formed by plasma enhanced chemical vapor deposition (PECVD), or inorganic material such as silicon nitride and silicon oxide. The passivation layer 180 may have a double-layered structure including a lower inorganic film and an upper organic film for preventing direct contact between the semiconductor islands 150 and an organic film.

The passivation layer 180 has a plurality of contact holes 182 and 185 exposing end portions 179 of the data lines 171 and the drain electrodes 175, respectively. The passivation layer 180 and the gate insulating layer 140 have a plurality of contact holes 181 exposing end portions 129 of the gate lines 121. The contact holes 181, 182 and 185 can have various shapes such as polygon or circle. The area of each contact hole 181, 182 or 185 is preferably equal to or larger than 0.5 mm×15 μm and not larger than 2 mm×60 μm. The sidewalls of the contact holes 181, 182 and 185 are inclined with an angle of about 30-85 degrees or have stepwise profiles.

A plurality of pixel electrodes 190 and a plurality of contact assistants 81 and 82, which are preferably made of ITO, IZO or Cr, are formed on the passivation layer 180.

The pixel electrodes 190 are physically and electrically connected to the drain electrodes 175 through the contact holes 185 such that the pixel electrodes 190 receive the data voltages from the drain electrodes 175. The pixel electrodes 190 supplied with the data voltages generate electric fields in cooperation with the common electrode 270, which reorient liquid crystal molecules disposed therebetween.

A pixel electrode 190 and a common electrode 270 form a capacitor called a “liquid crystal capacitor,” which stores applied voltages after turn-off of the TFT. An additional capacitor called a “storage capacitor,” which is connected in parallel to the liquid crystal capacitor, is provided for enhancing the voltage storing capacity. The storage capacitors are implemented by overlapping the pixel electrodes 190 with the storage electrode lines 131. The capacitances of the storage capacitors, i.e., the storage capacitances can be increased by providing a plurality of storage capacitor conductors, which are electrically connected to the pixel electrodes 190, between the gate insulating layer 140 and the passivation layer 180 opposite the pixel electrodes 190 and the storage electrodes lines 131.

The pixel electrodes 190 overlap the data lines 171 to increase aperture ratio but it is optional.

The contact assistants 81 and 82 are connected to the exposed end portions 129 of the gate lines 121 and the exposed end portions 179 of the data lines 171 through the contact holes 181 and 182, respectively. The contact assistants 81 and 82 are not requisites but preferred to protect the exposed portions 129 and 179 and to complement the adhesiveness of the exposed portions 129 and 179 and external devices.

Portions of the passivation layer 180 near the contact assistants 81 and 82 may be completely removed, and such a removal is particularly advantageous for a chip-on-glass type LCD.

The description of the common electrode panel 200 follows.

A black matrix 220 for preventing light leakage is formed on an insulating substrate 210 such as transparent glass and the black matrix 220 includes a plurality of openings facing the pixel electrodes 190 and having substantially the same shape as the pixel electrodes 190.

A plurality of red, green and blue color filters 230 are formed substantially in the openings of the black matrix 220. An exemplary arrangement of the color filters 230 is a stripe type that the color filters 230 in a column represent the same color.

A common electrode 270 preferably made of transparent conductive material such as ITO and IZO is formed on the color filters 230 and the black matrix 220. The common electrode 270 covers entire surface of the panel 200.

The wider surfaces of the spacers 320 are in contact with the common electrode panel 200 as shown in FIG. 8 or in contact with the TFT array panel as shown in FIG. 9. Although FIGS. 7-9 show the spacers 320 located on the data lines 171, the spacers 320 can be located on the gate lines 121, the TFTs, or any places covered by the black matrix 220.

A pair of polarizers (not shown) are provided on outer surfaces of the panels 100 and 200.

The LCD may be a twisted nematic (TN) mode LCD where liquid crystal molecules in the liquid crystal layer 300 having positive dielectric anisotropy are aligned parallel to surfaces of the panels 100 and 200 and the molecular orientations are twisted from the surface of one of the panels 100 to the surface of the other of the panels 100 and 200 in absence of electric field. Alternatively, the LCD is a vertically aligned (VA) mode LCD, that is, the liquid crystal molecules in the liquid crystal layer 300 with negative dielectric anisotropy are aligned vertical to surfaces of the panels 100 and 200 in absence of electric field. Alternatively, the LCD is an optically compensated bend (OCB) mode LCD, where the liquid crystal molecules have a bend alignment symmetrical with respect to a mid-plane between the panels 100 and 200 in absence of electric field.

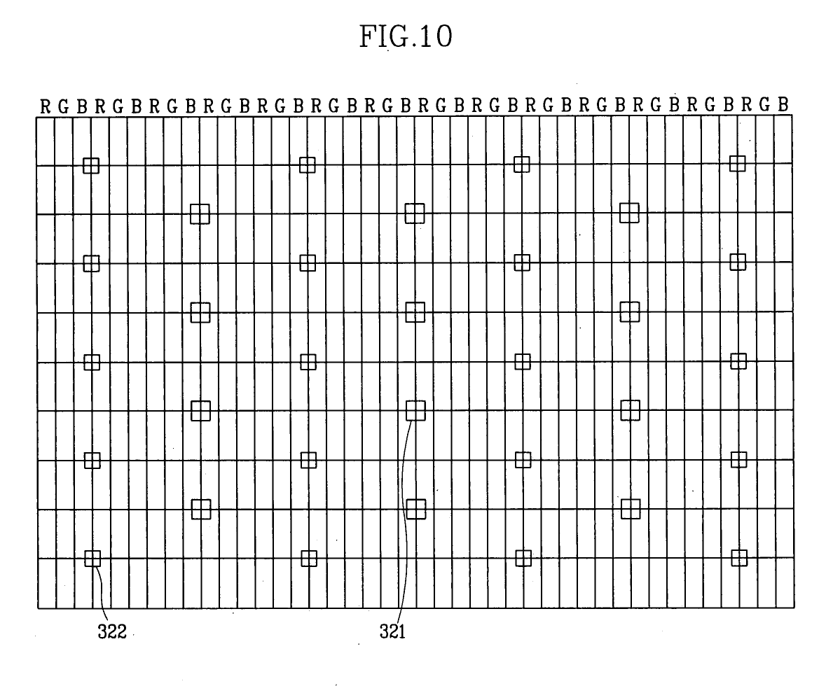

FIG. 10 shows exemplary locations of the first and the second spacers 321 and 322 shown in FIG. 2 according to an embodiment of the present invention.

Referring to FIG. 10, a plurality of red, green and blue color filters R, G and B are arranged in a stripe type. The spacers 321 and 322 are arranged in a regular or periodic manner along a row direction and a column direction. For example, the spacers 321 and 322 are located between the blue filters B and the red filters R and spaced apart from each other by predetermined transverse and longitudinal distances as shown in FIG. 10. The concentration of the first spacers 321 is preferably in a range of about 200-600/cm², while that of the second spacers is preferably in a range of about 250-450/cm².

A method of manufacturing a panel assembly for an LCD shown in FIGS. 7 and 9 is now described in detail with reference to FIGS. 1 and 2 as well as FIGS. 7 and 9.

Referring to FIGS. 7 and 9, a plurality of gate lines 121, a plurality of data lines 171, a plurality of TFTs, a plurality of pixel electrodes 190 and the like are formed on an insulating substrate 110 to form a TFT array panel 100. An organic insulating material is deposited on the panel 100 and patterned by photolithography to form a plurality of spacers 321 and 322 between the pixel areas. Meanwhile, a black matrix 220, a plurality of red, green and blue color filters 230, a common electrode 270, and so on are formed on another substrate 210 to form a common electrode panel 200. It is preferable that the size of the spacers 321 and 322 is equal to about 110-130% of the distance between the panels 100 and 200. The formation of the spacers 321 and 322 using photolithography enables to uniformly arrange the spacers 321 and 322 such that a thin uniform cell gap can be obtained throughout the panels 100 and 200 and the spacers 321 and 322 are prevented from being placed on the pixel electrodes 190, thereby improving the display characteristics.

Thereafter, a sealant 310 is coated on one of the panels 100 and 200 as shown in FIGS. 1 and 2. The sealant 310 has a shape of a closed loop without an injection hole for injecting LC. The sealant 310 may be made of thermosetting material or ultraviolet-hardening material and may contain a plurality of spacers for keeping the gap between the panels 100 and 200. Since the sealant 310 has no injection hole, it is important to exactly control the amount of the LC material. In order to solve any problem due to the excessive amount of the LC or the insufficient amount of the LC, a buffer region without LC material even after the termination of the panel combination is preferably provided at the sealant 310. Meanwhile, it is preferable that the sealant 310 has an anti-reaction film on its surface, which is not reactant with the LC layer 3.

A LC material is coated or dropped using a LC coater on the one of the panels 100 and 200 coated with the sealant 310. The LC coater may have a dice shape such that it can drop the LC material at the LC device areas 51-54. The LC may be sprayed on the entire surface of the LC device areas 51-54. In this case, the LC coater has a shape of a sprayer.

The panels 100 and 200 are delivered to an assembly device with a vacuum chamber. The room surrounded by the panels 100 and 200 and the sealant 310 is evacuated and the panels 100 and 200 are closely adhered to each other using atmospheric pressure such that the distance between the panels 100 and 200 reaches a desired cell gap. The sealant 310 is completely hardened with the illumination of an ultra-violet (UV) ray using a light exposer. In this way, the two panels 100 and 200 are assembled to form a panel assembly. The two panels 100 and 200 are exactly aligned to a minute order during the step of adhering the panels 100 and 200 and the step of illuminating UV ray on the sealant 310.

Finally, the panel assembly 40 is separated into the LC device areas 51-54 using a scribing machine.

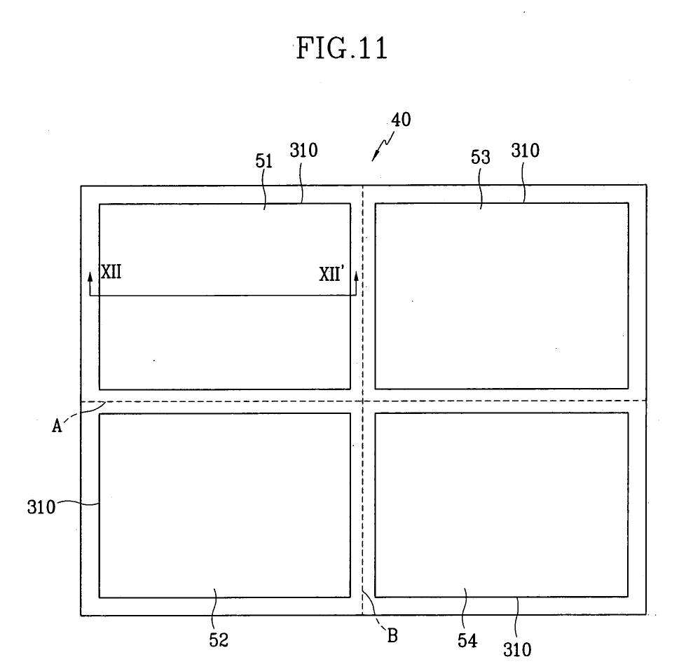

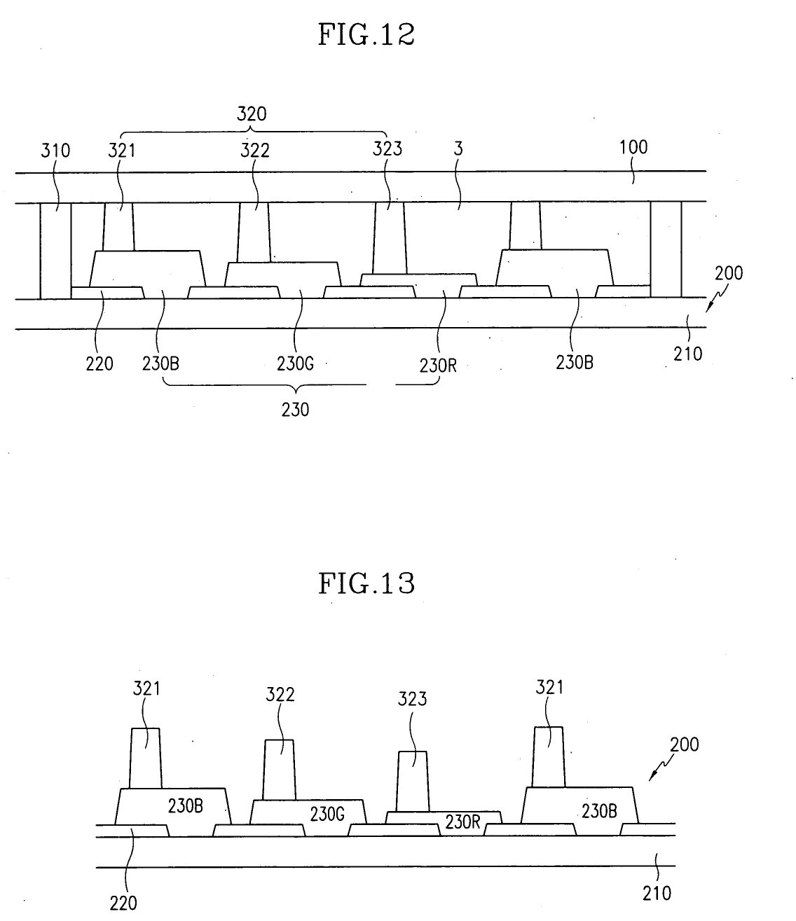

A panel assembly for LCDs according to another embodiment of the present invention will be now described in detail with reference to FIGS. 11 and 12.

FIG. 11 is a plan view of a panel assembly for LCDs according to another embodiment of the present invention and FIG. 12 is a sectional view of the panel assembly shown in FIG. 11 taken along the line XII-XII′.

As shown in FIGS. 11 and 12, a panel assembly 40 according to another embodiment of the present invention includes two panels 100 and 200 and a plurality of LC layers 3, a plurality of sealants 310, and a plurality of columnar spacers 320, which are disposed between the two panels 100 and 200.

The panel assembly 40 includes a plurality of, for example, four device areas divided by dotted lines A and B. The panel assembly 40 is separated into the respective LCDs by scribing the panel assembly 40 along the dotted lines A and B.

Each of the device areas (or an LCD) includes a display area 51, 52, 53 or 54 for displaying images. The display area 51 is substantially enclosed by the sealant 310, which confines the LC layer 3. The LC layer 3 may be formed after the panel assembly 40 is separated into the respective devices. The sealant 310 may contain spacers for supporting the panels 10 and 20 to be parallel to each other.

The panel 200 includes an insulating substrate 210, a black matrix 220 formed on the substrate 210, a plurality of color filters 230 formed on the black matrix 220 and the substrate 210, and a common electrode (not shown) formed thereon. The color filters 230 include a plurality of red filters 230R, a plurality of green filters 230G, and a plurality of blue filters 230B. The blue filters 230B, the green filters 230G, and the red filters 230R are sequentially arranged in a transverse direction and have decreasing thicknesses as shown in FIG. 12.

As shown in FIG. 12, the spacers 320 for maintaining a gap between the panels 100 and 200 to be uniform includes a plurality of first, second, and third spacers 321-323 formed on the blue filters 230B, the green filters 230G, and the red filters 230R, respectively, and contacting the panels 100 and 200 with different contact areas. The different contact areas of the spacers 321-323 are obtained by forming spacer columns having the same thickness but having different top heights due to the different thickness of the color filters 230 and by pressing the spacer columns such that the top surfaces of the spacer columns have the same height.

FIG. 13 is a sectional view of a panel and a plurality of column spacers formed thereon for the LCD shown in FIG. 12 before panel combination according to another embodiment of the present invention.

A panel 200 includes an insulating substrate 210, and a black matrix 220, a plurality of color filters 230, and a common electrode (not shown), which are sequentially formed on the substrate.210. The color filters 230 include a plurality of red filters 230R, a plurality of green filters 230G, and a plurality of blue filters 230B having decreasing thicknesses as shown in FIG. 13.

A plurality of first, second, and third column spacers 321-323 having the same height are formed on the blue filters 230B, the green filters 230G, and the red filters 230R, respectively. The heights of top surfaces of the first to the third spacers 321-323 are different due to the different thickness of the color filters 230B, 230G, 230R as shown in FIG. 13. The thickness of the green filters 230G and the red filters 230R may be equal to equalizing the top heights of the second and the third spacers 322 and 323.

The first spacers 321, which are primary spacers, keep a cell gap between the two panels 100 and 200 uniform during a normal operation. The second and the third spacers 322 and 323 prevent the excessive reduction of the cell gap due to an external pressure.

The different contact areas of the spacers 321-323 are also obtained by forming spacer columns having different thicknesses with or without the different thicknesses of the color filters 230 and by pressing the spacer columns such that the top surfaces of the spacer columns have the same height.

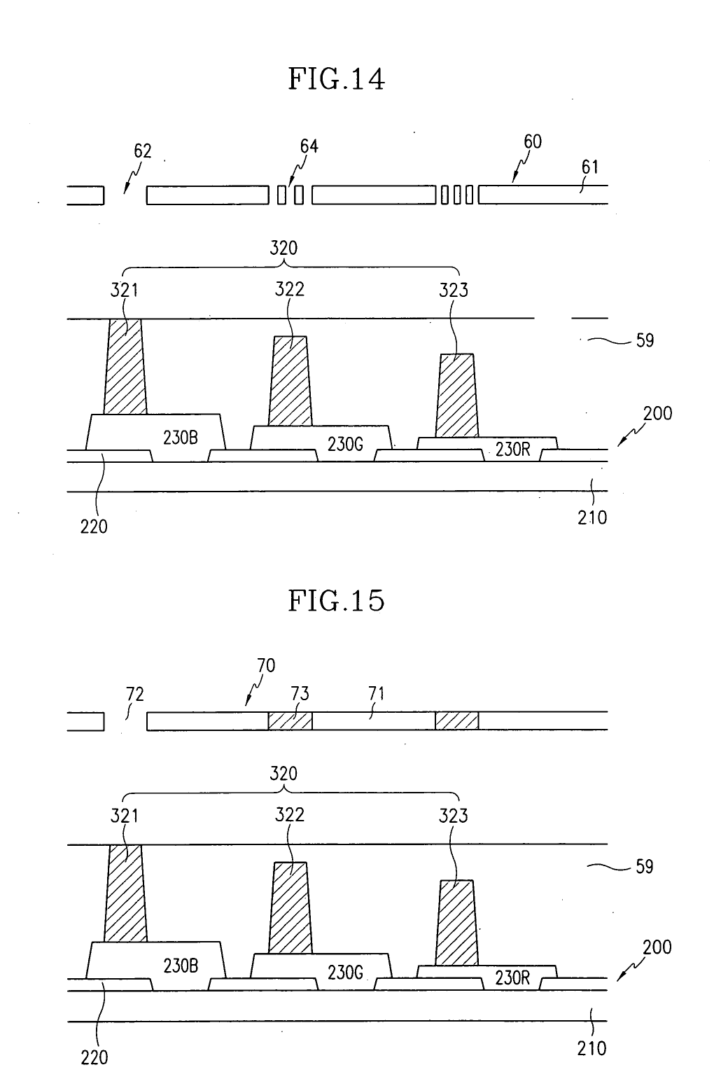

Now, methods of manufacturing spacers having different thicknesses according to embodiments of the present invention are described in detail with reference to FIGS. 14 and 15.

FIG. 14 is a sectional view of a LC panel assembly in an intermediate step of a manufacturing method thereof according to an embodiment of the present invention.

Referring to FIG. 14, a negative acrylic photoresist 59 is coated on a LC panel 200. An exposure mask 60 including an opaque film 61 having a plurality of openings 62 and a plurality of slit areas 64 are disposed on the panel 200. The slit areas 64 includes a plurality of slits and may have at least two slit areas with different slit widths and different slit distances. The exposure mask 60 is aligned such that the openings 62 face portions of the photoresist 59 to become the tallest spacers 321 and the slit areas 64 face portions of the photoresist 59 to become other spacers 322 and 323. The photoresist 59 is then exposed to light from a light source through the exposure mask 60 so that the portions of the photoresist 59 exposed to light be hardened. A portion facing a slit area 64 having smaller slit width and smaller slit distance becomes a shorter spacer.

FIG. 15 is a sectional view of a LC panel assembly in an intermediate step of a manufacturing method thereof according to another embodiment of the present invention.

Referring to FIG. 15, after a negative acrylic photoresist 59 is coated on a LC panel 200, an exposure mask 70 having a plurality of transparent areas 72, a plurality of translucent areas 73, and an opaque area 71 is disposed on the panel 200. The opaque area 71 and each translucent area 73 include an opaque film and a translucent film, respectively, while each transparent area 72 has an opening. The translucent areas 73 may include at least two translucent areas having different transmittances. The exposure mask 70 is aligned such that the transparent areas 72 and the translucent areas 73 face portions of the photoresist 59 to become the tallest spacers 321 and the remaining spacers 322 and 323, respectively. The photoresist 59 is then exposed to light from a light source through the exposure mask 70. A portion facing a translucent area 73 having smaller transmittance becomes a shorter spacer.

The spacers 321-323 may be made from a positive photoresist, and in this case, the opaque areas and the transparent areas shown in FIGS. 4A-6 are reversed.

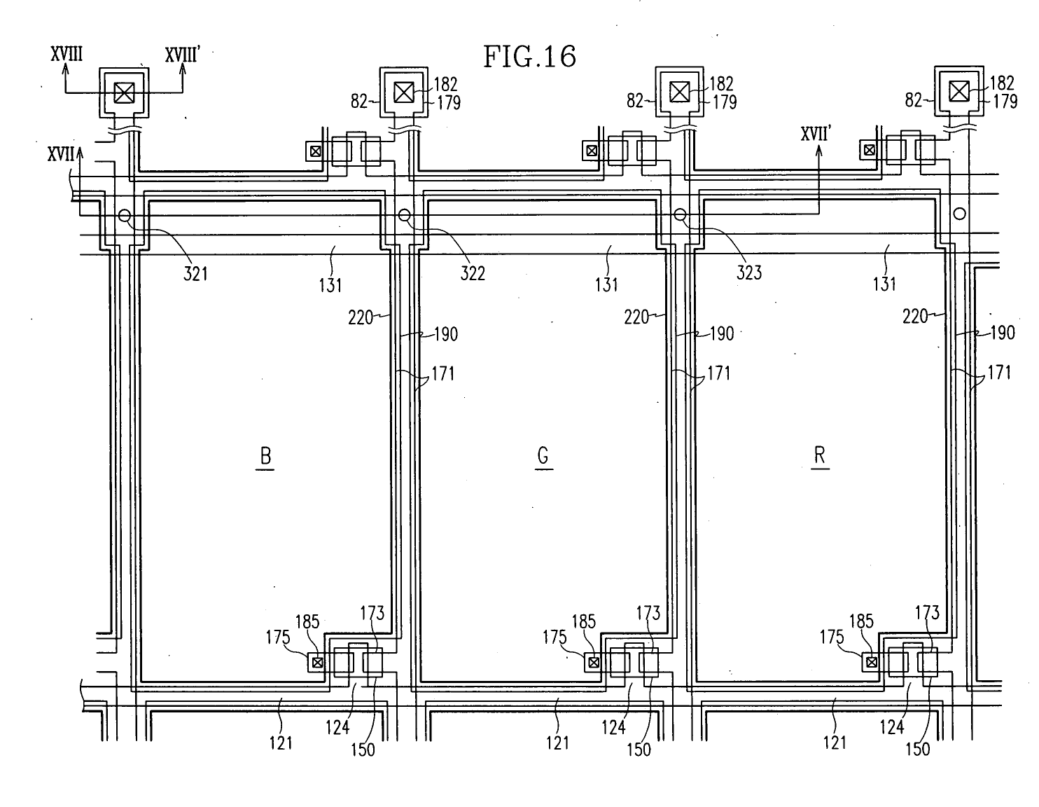

An exemplary LC panel assembly according to an embodiment of the present invention will be described in more detail with reference to FIGS. 16-18.

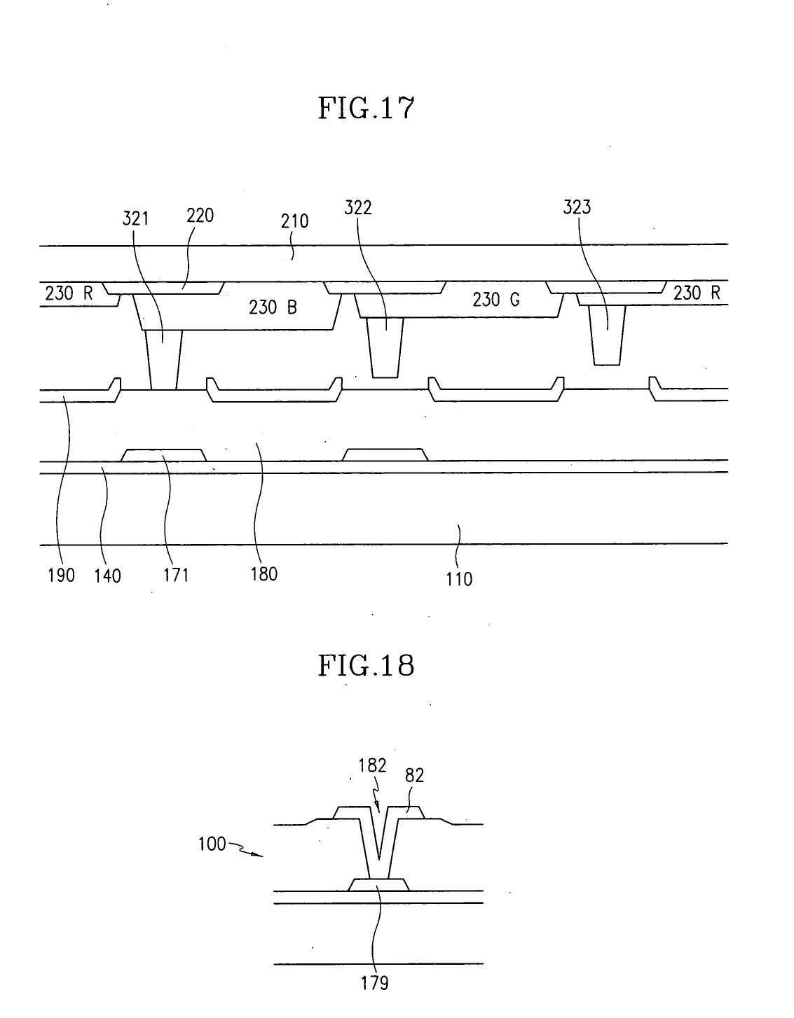

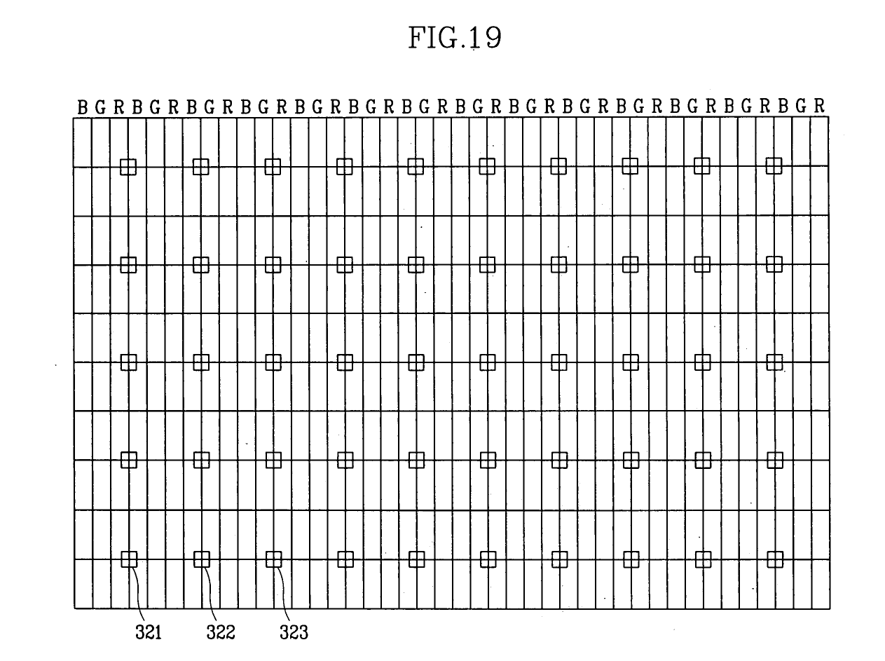

FIG. 16 is a layout view of an LCD according to an embodiment of the present invention, and FIGS. 17 and 18 are sectional views of the LCD shown in FIG. 16 taken along the line XVII-XVII′ and the line XVIII-XVIII′, respectively.

An LCD according to an embodiment of the present invention includes a TFT array panel 100, a color filter panel 200, and a LC layer 3 and a plurality of column spacers 321-323 disposed between the panels 100 and 200.

The TFT array panel 100 is now described in detail.

A plurality of gate lines 121 for transmitting gate signals and a plurality of storage electrode lines 131 are formed on an insulating substrate 110.

The gate lines 121 and the storage electrode lines 131 extend substantially in a transverse direction and are separated from each other. A plurality of projections of each gate line 121 form a plurality of gate electrodes 124. The storage electrode lines 131 are supplied with a predetermined voltage such as a common voltage, which is applied to a common electrode on the color filter panel 200 of the LCD.

The gate lines 121 and the storage electrode lines 131 may have a multi-layered structure including two films having different physical characteristics, a lower film (not shown) and an upper film (not shown). The upper film is preferably made of low resistivity metal including Al containing metal such as Al and Al alloy for reducing signal delay or voltage drop in the gate lines 121 and the storage electrode lines 131. On the other hand, the lower film is preferably made of material such as Cr, Mo and Mo alloy, which has good contact characteristics with other materials such as indium tin oxide (ITO) or indium zinc oxide (IZO). A good exemplary combination of the lower film material and the upper film material is Cr and Al—Nd alloy.

In addition, the lateral sides of the gate lines 121 and the storage electrode lines 131 are tapered, and the inclination angle of the lateral sides with respect to a surface of the substrate 110 ranges about 30-80 degrees.

A gate insulating layer 140 preferably made of silicon nitride (SiNx) is formed on the gate lines 121 and the storage electrode lines 131.

A plurality of semiconductor islands 150 preferably made of hydrogenated amorphous silicon (abbreviated as “a-Si”) or polysilicon are formed on the gate insulating layer 140. The semiconductor islands 150 are located opposite the respective gate electrodes 124.

A plurality of ohmic contact islands 163 and 165 preferably made of silicide or n+ hydrogenated a-Si heavily doped with n type impurity are formed on the semiconductor islands 150.

The lateral sides of the semiconductor islands 150 and the ohmic contacts 163 and 165 are tapered, and the inclination angles thereof are preferably in a range between about 30-80 degrees.

A plurality of data lines 171 and a plurality of drain electrodes 175 separated from each other are formed on the ohmic contacts 163 and 165 and the gate insulating layer 140.

The data lines 171 for transmitting data voltages extend substantially in the longitudinal direction and intersect the gate lines 121 and the storage electrode lines 131. A plurality of branches of each data line 171, which project toward the drain electrodes 175, form a plurality of source electrodes 173. A source electrode 173 and a drain electrode 175 in a pair are separated from each other and opposite each other with respect to a gate electrode 124. A gate electrode 124, a source electrode 173, and a drain electrode 175 along with the semiconductor island 150 form a TFT having a channel between the source electrode 173 and the drain electrode 175.

The data lines 171 and the drain electrodes 175 may also include a lower film (not shown) preferably made of Mo, Mo alloy or Cr and an upper film (not shown) located thereon and preferably made of Al containing metal.

Like the gate lines 121 and the storage electrode lines 131, the data lines 171 and the drain electrodes 175 have tapered lateral sides, and the inclination angles thereof range about 30-80 degrees.

The ohmic contacts 163 and 165 are interposed only between the underlying semiconductor islands 150 and the overlying data lines 171 and the overlying drain electrodes 175 thereon and reduce the contact resistance therebetween.

A passivation layer 180 is formed on the data lines 171 and the drain electrodes 175, and exposed portions of the semiconductor islands 150, which are not covered with the data lines 171 and the drain electrodes 175. The passivation layer 180 is preferably made of photosensitive organic material having a good flatness characteristic, low dielectric insulating material such as a-Si:C:O and a-Si:O:F formed by plasma enhanced chemical vapor deposition (PECVD), or inorganic material such as silicon nitride and silicon oxide. The passivation layer 180 may have a double-layered structure including a lower inorganic film and an upper organic film for preventing direct contact between the semiconductor islands 150 and an organic film.

The passivation layer 180 has a plurality of contact holes 182 and 185 exposing end portions 179 of the data lines 171 and the drain electrodes 175, respectively. The contact holes 182 and 185 can have various shapes such as polygon or circle. The area of each contact hole 182 or 185 is preferably equal to or larger than 0.5 mm×15 μm and not larger than 2 mm×60 μm. The sidewalls of the contact holes 182 and 185 are inclined with an angle of about 30-85 degrees or have stepwise profiles.

A plurality of pixel electrodes 190 and a plurality of contact assistants 82, which are preferably made of ITO, IZO or Cr, are formed on the passivation layer 180.

The pixel electrodes 190 are physically and electrically connected to the drain electrodes 175 through the contact holes 185 such that the pixel electrodes 190 receive the data voltages from the drain electrodes 175. The pixel electrodes 190 supplied with the data voltages generate electric fields in cooperation with the common electrode, which reorient liquid crystal molecules disposed therebetween.

The pixel electrodes 190 overlap the data lines 171 to increase aperture ratio but it is optional.

The contact assistants 82 are connected to the exposed end portions 179 of the data lines 171 through the contact holes 182. The contact assistants 82 are not requisites but preferred to protect the exposed portions 179 of the data lines 171 and to complement the adhesiveness of the exposed portions 179 and external devices.

Portions of the passivation layer 180 near the contact assistants 82 may be completely removed, and such a removal is particularly advantageous for a chip-on-glass type LCD.

The description of the color filter panel 200 follows.

A black matrix 220 for preventing light leakage is formed on an insulating substrate 210 such as transparent glass and the black matrix 220 includes a plurality of openings facing the pixel electrodes 190 and having substantially the same shape as the pixel electrodes 190.

A plurality of red, green and blue color filters 230B, 230G and 230R are formed substantially in the openings of the black matrix 220. An exemplary arrangement of the color filters 230B, 230G and 230R is a stripe type that the color filters 230B, 230G and 230R in a column represent the same color.

A common electrode (not shown) preferably made of transparent conductive material such as ITO and IZO is formed on the color filters 230B, 230G and 230R and the black matrix 220. The common electrode covers entire surface of the panel 200.

The wider surfaces of the spacers 321-323 are in contact with the color filter panel 200 as shown in FIG. 17. Although FIGS. 16-18 show the spacers 321-323 located on the data lines 171, the spacers 321-323 can be located on the gate lines 121, the TFTs, or any places covered by the black matrix 220.

A pair of polarizers (not shown) are provided on outer surfaces of the panels 100 and 200.

The LCD may be a twisted nematic (TN) mode LCD where liquid crystal molecules in the liquid crystal layer 300 having positive dielectric anisotropy are aligned parallel to surfaces of the panels 100 and 200 and the molecular orientations are twisted from the surface of one of the panels 100 and 200 to the surface of the other of the panels 100 and 200 in absence of electric field. Alternatively, the LCD is a vertically aligned (VA) mode LCD, that is, the liquid crystal molecules in the liquid crystal layer 300 with negative dielectric anisotropy are aligned vertical to surfaces of the panels 100 and 200 in absence of electric field. Alternatively, the LCD is an optically compensated bend (OCB) mode LCD, where the liquid crystal molecules have a bend alignment symmetrical with respect to a mid-plane between the panels 100 and 200 in absence of electric field.

FIG. 19 shows exemplary locations of the spacers 321-323 shown in FIGS. 12-18 according to an embodiment of the present invention.

Referring to FIG. 19, a plurality of red, green and blue color filters R, G and B are arranged in a stripe type. Three kinds of spacers 321-323 are arranged in a regular or periodic manner along a row direction and a column direction. For example, the different kinds of the spacers 321-323 are located between the color filters having different colors and spaced apart from each other by predetermined transverse and longitudinal distances as shown in FIG. 19.

A method of manufacturing a panel assembly for an LCD shown in FIGS. 16-18 is now described in detail with reference to FIGS. 11 and 12 as well as FIGS. 16-17.

Referring to FIGS. 16 and 17, a plurality of gate lines 121, a plurality of data lines 171, a plurality of TFTs, a plurality of pixel electrodes 190 and the like are formed on an insulating substrate 110 to form a TFT array panel 100. Meanwhile, a black matrix 220, a plurality of red, green and blue color filters 230R, 230G and 230B, a common electrode (not shown), and so on are formed on another substrate 210 to form a color filter panel 200. An organic insulating material is deposited on the panel 200 and patterned by photolithography to form a plurality of spacers 321-323 located on the respective color filters 230B, 230G and 230R. It is preferable that the size of the spacers 321-323 is equal to about 110-130% of the distance between the panels 100 and 200. The formation of the spacers 321-323 using photolithography enables to uniformly arrange the spacers 321-323 such that a thin uniform cell gap can be obtained throughout the panels 100 and 200 and the spacers 321-323 are prevented from being placed on the pixel electrodes 190, thereby improving the display characteristics.

Thereafter, a sealant 310 is coated on one of the panels 100 and 200 as shown in FIGS. 1 and 2. The sealant 310 has a shape of a closed loop without an injection hole for injecting LC. The sealant 310 may be made of thermosetting material or ultraviolet-hardening material and may contain a plurality of spacers for keeping the gap between the panels 100 and 200. Since the sealant 310 has no injection hole, it is important to exactly control the amount of the LC material. In order to solve any problem due to the excessive amount of the LC or the insufficient amount of the LC, a buffer region without LC material even after the termination of the panel combination is preferably provided at the sealant 310. Meanwhile, it is preferable that the sealant 310 has an anti-reaction film on its surface, which is not reactant with the LC layer 3.

A LC material is coated or dropped using a LC coater on the one of the panels 100 and 200 coated with the sealant 310. The LC coater may have a dice shape such that it can drop the LC material at the LC device areas 51-54. The LC may be sprayed on the entire surface of the LC device areas 51-54. In this case, the LC coater has a shape of a sprayer.

The panels 100 and 200 are delivered to an assembly device with a vacuum chamber. The room surrounded by the panels 100 and 200 and the sealant 310 is evacuated and the panels 100 and 200 are closely adhered to each other using atmospheric pressure. A member for pressing the panels 100 and 200 may be provided for obtaining a desired cell gap.

The sealant 310 is completely hardened with the illumination of an ultra-violet (UV) ray using a light exposer. In this way, the two panels 100 and 200 are assembled to form a panel assembly. The two panels 100 and 200 are exactly aligned to a minute order during the step of adhering the panels 100 and 200 and the step of illuminating UV ray on the sealant 310.

Finally, the panel assembly 40 is separated into the LC device areas 51-54 using a scribing machine.

To summarize, the present invention differentiates the areas and the heights of the spacers supporting the panels to keep the cell gap uniform and to facilitate the formation of the LC layer. In addition, the concentration of the spacers can be reduced to prevent the light leakage due to the press.

What is claimed is:

1. A panel assembly for a display device, the panel assembly comprising:
a panel; and
a plurality of spacers formed on the panel for supporting the panel,
wherein the spacers have at least two different heights or at least two different contact areas with the panel.

2. The panel assembly of claim 1, wherein the contact areas of the spacers are circular or tetragonal.

3. The panel assembly of claim 1, wherein the spacers comprise a plurality of first spacers and a plurality of second spacers having a height lower than the first spacers and having a contact area wider than the first spacers.

4. The panel assembly of claim 3, wherein the height difference between the first spacers and the second spacers is in a range of about 0.3-0.6 microns.

5. The panel assembly of claim 3, wherein the second spacers have a length larger than the first spacers by 10-20 microns.

6. The panel assembly of claim 3, wherein the second spacers have a length in a range of about 30-35 microns and the first spacers have a length in a range of about 15-20 microns.

7. The panel assembly of claim 3, wherein a concentration of the second spacers is about 200-600/cm² and a concentration of the first spacer is about 250-450/cm².

8. The panel assembly of claim 1, wherein the spacers comprise a first spacer, a second spacer having a height lower than the first spacer, and a third spacer having a height equal to or lower than the second spacer.

9. The panel assembly of claim 8, wherein the height of the third spacer is equal to the height of the second spacer.

10. The panel assembly of claim 1, wherein the panel comprises a gate line and a data line transmitting electrical signals, a thin film transistor electrically connected to the gate line and the data line, and a pixel electrode connected to the thin film transistor.

11. The panel assembly of claim 1, wherein the panel comprises a plurality of color filters having different thicknesses.

12. A liquid crystal display, comprising:
a first panel;
a second panel opposite each other with a gap therebetween and including a pixel electrode, a switching element connected to the pixel electrode, and a gate line and a data line connected to the switching element for transmitting electrical signals;
a plurality of spacers formed between the first panel and the second panel for maintaining the gap; and
a liquid crystal layer filled in the gap,
wherein the spacers have at least two different contact areas with the panels.

13. A method of manufacturing a liquid crystal panel assembly, the method comprising:
coating a photoresist on a panel;
light-exposing the photoresist through an exposure mask including an opening and disposed on the panel with a first distance;
light-exposing the photoresist through the exposure mask disposed on the panel with a second distance; and
developing the photoresist to form first and second spacers having different heights or different contact areas with the panel.

14. The method of claim 13, wherein the photoresist is a negative type.

15. A method of manufacturing a liquid crystal panel, the method comprising:
coating a photoresist on a panel;
light-exposing the photoresist through a first exposure mask including a first opening;
light-exposing the photoresist through a second exposure mask including a second opening; and
developing the photoresist to form first and second spacers having different heights or different contact areas with the panel.

16. The method of claim 15, wherein the photoresist is a negative type.

17. A method of manufacturing a liquid crystal panel, the method comprising:
coating a photoresist on a panel;
light-exposing the photoresist through an exposure mask including a plurality of transmissive areas having different transmittances and a blocking area; and
developing the photoresist to form a plurality of spacers having different heights or different contact areas with the panel.

18. The method of claim 17, wherein the plurality of transmissive areas comprise a transparent area and a translucent area.

19. The method of claim 18, wherein the transparent area has an opening and the translucent area has a plurality of slits.

20. The method of claim 17, wherein the plurality of transmissive areas comprise a transparent area and a plurality of translucent areas having different transmittances.

21. The method of claim 17, wherein the photoresist is a negative type.
